(19) United States
(12) Patent Application Publication
(10) Pub. No.: US 2012/0039677 A1
(43) Pub. Date: Feb. 16, 2012

(54) CONTOUR END MILL

(75) Inventor: Danny Ray Davis, Asheboro, NC (US)

(73) Assignee: Kennametal Inc., Latrobe, PA (US)

(21) Appl. No.: 12/854,841

(22) Filed: Aug. 11, 2010

(51) Int. Cl. B23C 5/10; B23C 5/14

(52) U.S. Cl. 407/54; 407/62; 409/131

(57) ABSTRACT

A contour end mill includes a shank portion and a cutting portion. The cutting portion defines a cutting diameter, a corner radius and a major radius. The major radius is greater than one-half of the cutting diameter. As a result, the end mill produces a much smoother finish and a reduced chip thickness.

### BACKGROUND OF THE INVENTION

End mills are widely used in milling operations due to their versatile range of application and due to the moderate cost of the tool. End mills are often of cylindrical shape, and are generally available up to about 80 mm diameter. Many end mills have flat ends; however other shapes such as conical and rounded ends are also used. Typically, an end mill has two (2) to ten (10) teeth, depending on diameter, size and whether configured for rough cutting or finishing. The teeth are usually spiral shaped, but can be straight and parallel to the longitudinal axis. Common materials used in the construction of end mills are high speed steel, solid carbide, cermets or ceramic, or combinations thereof.

Ball nose end mills are often used in difficult operations where demands are very high in terms of surface finish. In these applications, no unevenness and notches whatsoever may be tolerated that later may be able to cause failure, while simultaneous high productivity and predictable long tool life are highly desired. Further, the tool may not be exchanged during the machining operation which could result in worse precision of the manufactured part as the tool wears.

FIGS. 11(a) and (b) illustrate a typical cutting operation using a convention ball nose end mill using a predetermined step over width. As seen, the conventional ball nose end mill produces a somewhat rough finish in the form of sinusoidal scallops having a relatively large depth. In addition, the conventional ball nose end mill produces chips with relatively large thickness. This rough finish is unacceptable for operations that demand a smooth, even finish.

### SUMMARY OF THE INVENTION

The problem of rough finish and relatively large chip thickness associated with conventional end mills is solved by a contour end mill with a major radius that is greater than one-half of the cutting diameter.

In one aspect, a contour end mill comprises a shank portion; and a cutting portion defining a cutting diameter, a corner radius and a major radius, wherein the the major radius that is greater than one-half of the cutting diameter.

In another aspect, a contour end mill comprises a shank portion; and a cutting portion defining a cutting diameter, a corner radius and a major radius. The cutting portion further includes a plurality of flutes defining a core diameter, a radial rake angle, a rake check point, a radial primary angle, a radial secondary angle, a primary relief, a secondary relief, a helical axial rake gash, a heel relief, and a cutting edge formed at an intersection between the helical axial rake gash and the primary relief, wherein the the major radius that is greater than one-half of the cutting diameter, and wherein the corner radius is less than one-half of the cutting diameter.

In another aspect, a method of end milling a workpiece using a contour end mill comprises performing a cutting operation with the major radius of the cutting portion; and performing a cutting operation with the corner radius of the cutting portion.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

FIG. 1 is a plan side view of an exemplary embodiment of a contour end mill of the invention;

FIG. 2 is cross-sectional view of the end mill taken along line 2-2 of FIG. 1;

FIG. 3 is an enlarged cutaway view of the end mill of FIG. 1;

FIG. 4 is a plan end view of the end mill of FIG. 1;

FIG. 5 is a side view of a two-fluted contour end mill according to an embodiment of the invention;

FIG. 6 is an enlarged side view of the cutting portion of the end mill of FIG. 5;

FIG. 7 is another enlarged side view of the cutting portion of the end mill of FIG. 6 rotated ninety (90) degrees;

FIG. 8 is an end isometric view of the end mill of FIG. 5;

FIG. 9 is a plan view of a cutting operation using the end mill of the invention;

FIGS. 10(a) and (b) are plan views of a cutting operation showing improved finish a reduced chip thickness using the end mill of the invention; and

FIGS. 11(a) and (b) are plan view of a cutting operation showing unacceptable finish and increased chip thickness using a conventional end mill.

### DETAILED DESCRIPTION OF THE INVENTION

Below are illustrations and explanations for a version of combination end milling drilling/push drilling cutting tool and a method for machining a workpiece. However, it is noted that combination cutting tool and machining method may be configured to suit the specific application and is not limited only to the example in the illustrations.

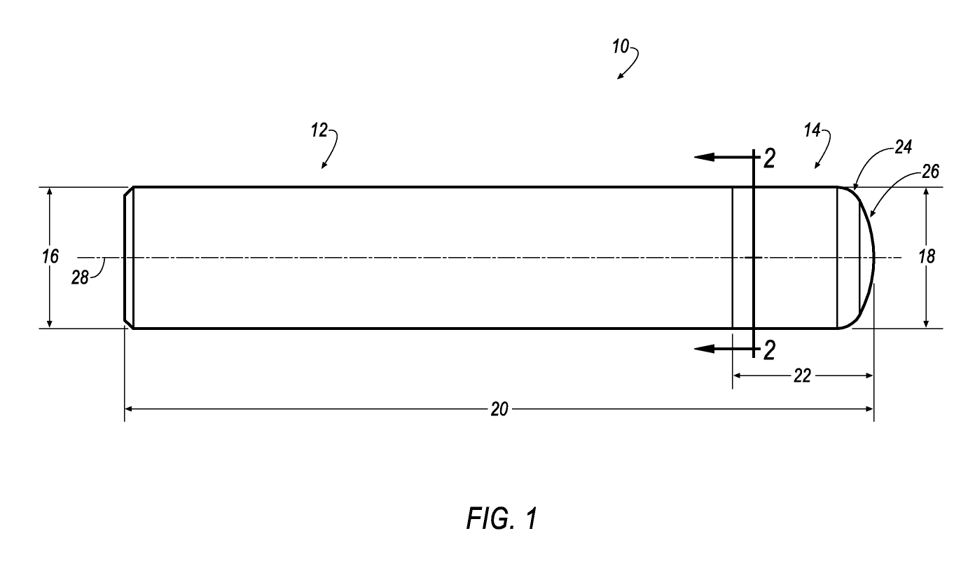

Referring to FIGS. 1-4, wherein like reference characters represent like elements, a contour end mill is generally shown at 10 according to an embodiment of the invention. In general, the end mill 10 has a shank portion 12 and a cutting portion 14. The shank portion 12 defines a shank diameter 16, and the cutting portion 14 defines a cutting diameter 18. In some embodiments, the shank diameter 16 is substantially equal to the cutting diameter 18. In other embodiments, the shank diameter 16 may be slightly larger or smaller than the cutting diameter 18. The end mill 10 has an overall length 20 and a length of cut 22. The cutting portion 14 includes a corner radius 24 and a major radius 26. The end mill 10 has a central, longitudinal axis 28.

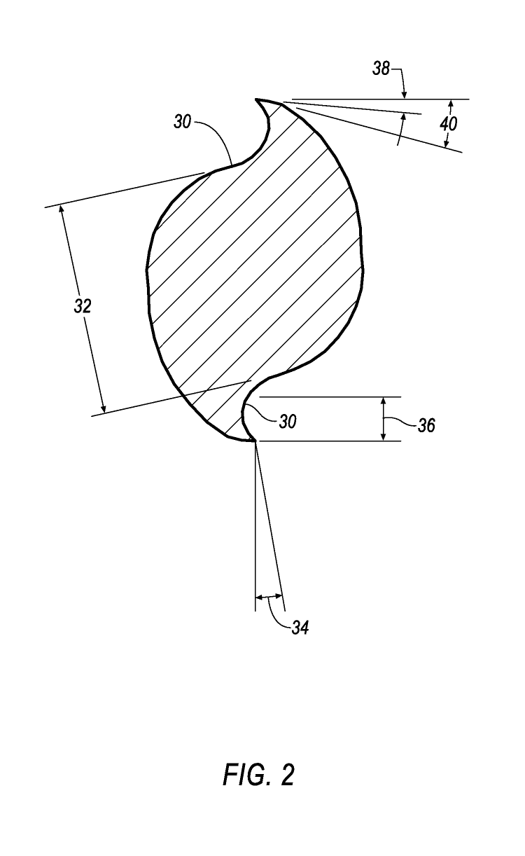

Referring now to FIG. 2, the cutting portion 14 of the end mill 10 includes two flutes 30 defining a core diameter 32, a radial rake angle 34, a rake check point 36, a radial primary angle 38 and a radial secondary angle 40. In one embodiment, the radial rake angle 34 is approximately +4 degrees, the radial primary angle 38 is approximately +9 degrees, and the radial secondary angle 40 is approximately +20 degrees.

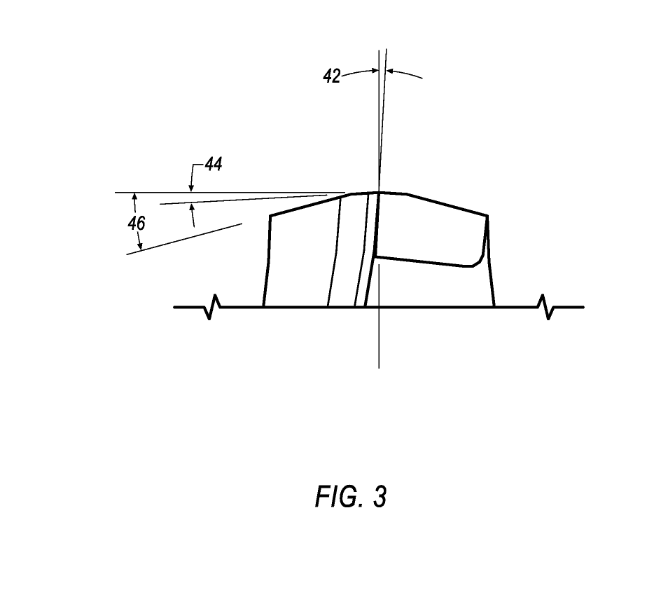

Referring now to FIG. 3, the cutting portion 14 of the end mill 10 includes an axial rake angle 42, an axial primary angle 44 and an axial secondary angle 46. In one embodiment, the axial rake angle is approximately +4 degrees, the axial primary angle 44 is approximately +9 degrees, and the axial secondary angle 40 is approximately +20 degrees.

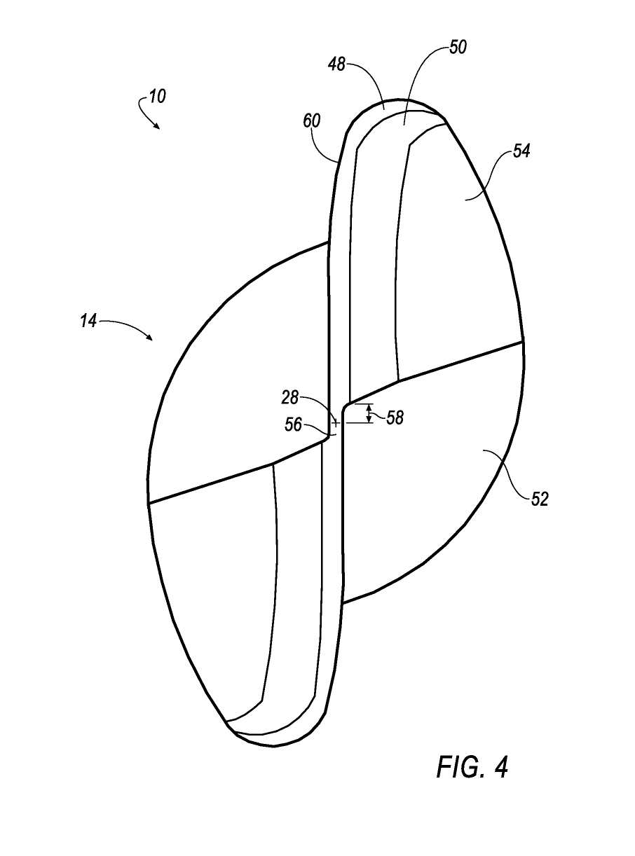

Referring now to FIG. 4, the cutting portion 14 of the end mill 10 includes a primary relief 48, a secondary relief 50, a helical axial rake gash 52, and a heel relief 54. A center web 56 has a non-zero thickness. In one embodiment, for example, the thickness of the center web 56 is approximately 0.006 inches (0.152 mm). The helical axial rake gash 52 is offset from the central, longitudinal axis 28 by a distance 58 to allow the axial rake to be substantially aligned with the central, longitudinal axis 28 of the end mill 10. In one embodiment, the distance 58 is approximately 0.006 inches (0.152 mm). The thickness of the center web 56 and the offset distance 58 is for illustrative purposes only, and the invention can be practiced with any desirable thickness and offset distance. A cutting edge 60 is formed at the intersection between the helical axial rake gash 52 and the primary relief 48. In the illustrated embodiment, the end mill 10 has two (2) cutting edges 60. However, it will be appreciated that the invention can be practiced with any desirable number of cutting edges 60, for example, more than two (2) cutting edges, and the like.

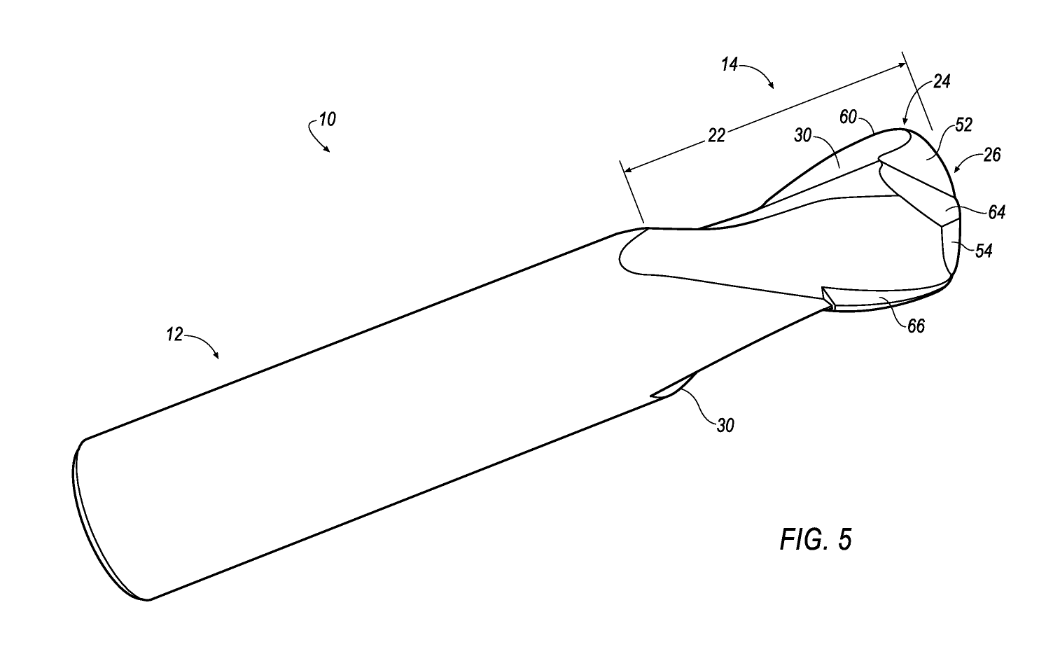

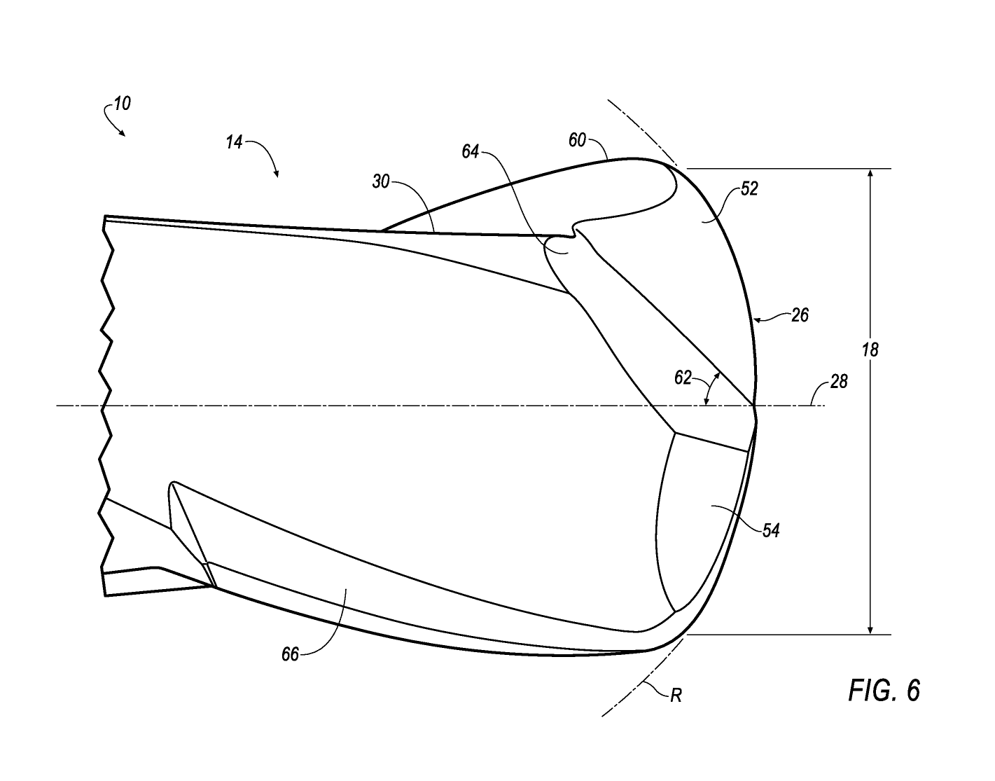

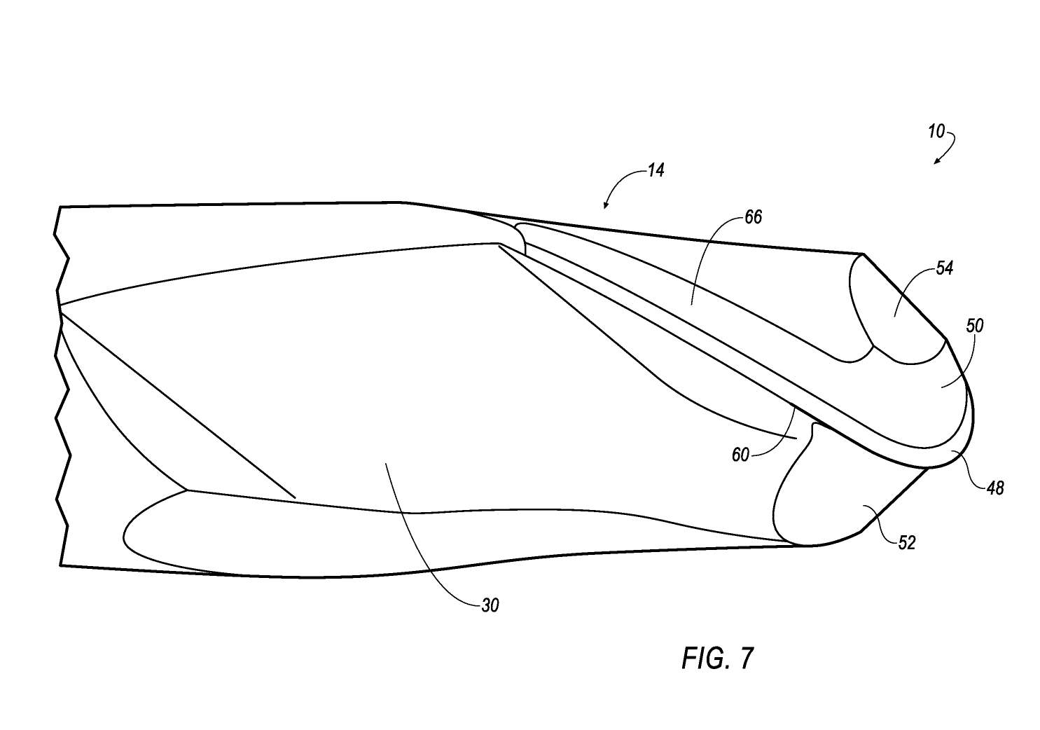

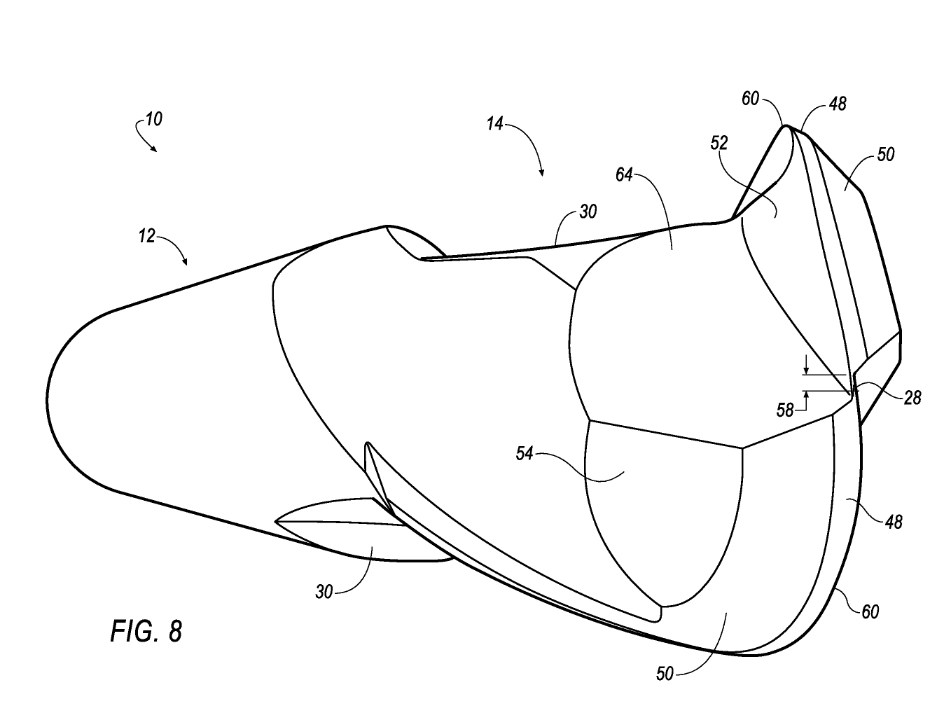

As seen in FIGS. 5-8, the helical axial rake gash 52 is formed at a gash angle 62 with respect to the central, longitudinal axis 28 of the end mill 10. In one embodiment, the gash angle 62 is approximately forty-five (45) degrees. It is noted that the end mill 10 also includes a bottom gash 64 between the helical axial rake gash 52 and the heel relief 54 for the adjacent flute 30 (not visible in FIG. 5). In one embodiment, the angle of the bottom gash 64 is approximately 110 degrees. In addition, the end mill 10 includes a radial and axial release 66.

In the invention, the corner radius 24 and the major radius 26 are defined as a function of the cutting diameter 18. For example, the corner radius 24 is less than one-half of the cutting diameter 18. For example, in the illustrated embodiment, the corner radius 24 is approximately 0.18 times the cutting diameter 18.

In one aspect of the invention, the major radius 26 is greater than one-half of the cutting diameter 18 of the end mill 10. For example, in the illustrated embodiment, the major radius 26 is 0.85 times the cutting diameter 18. However, it will be appreciated that the major radius 26 can be any value greater than 0.50 times the cutting diameter 18. For example, the major radius 26 can be 0.51 times the cutting diameter 18, 0.52 times the cutting diameter 26, . . . , 0.99 times the cutting diameter 26, as well as values in thousandths in between.

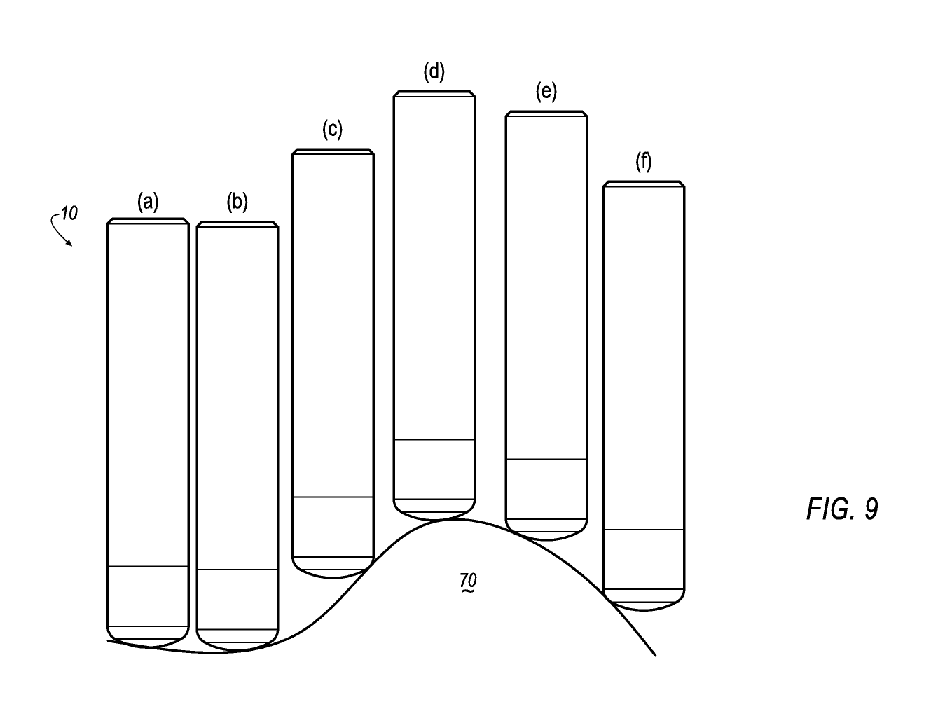

As shown in FIGS. 9(a)-(f), the end mill 10 of the invention provides superior cutting performance as compared to conventional end mills. The superior cutting performance is achieved by the use of both the corner radius 24 and the major radius 26 of the end mill 10 during the cutting operation. As shown in FIGS. (a), (b), (d) and (e), the major radius 26 is performing the cutting operation of the workpiece 70. However, in FIGS. (c) and (f), the corner radius 24 is performing the cutting operation of the workpiece 70. Because both the corner radius 24 and the major radius 26 of the end mill 10 can be used during the cutting operation, the end mill 10 of the invention can provide superior cutting performance on the most complicated three-dimensional workpieces. By contrast, conventional end mills are incapable of performing the same type of cutting operation on such complicated three-dimensional workpieces.

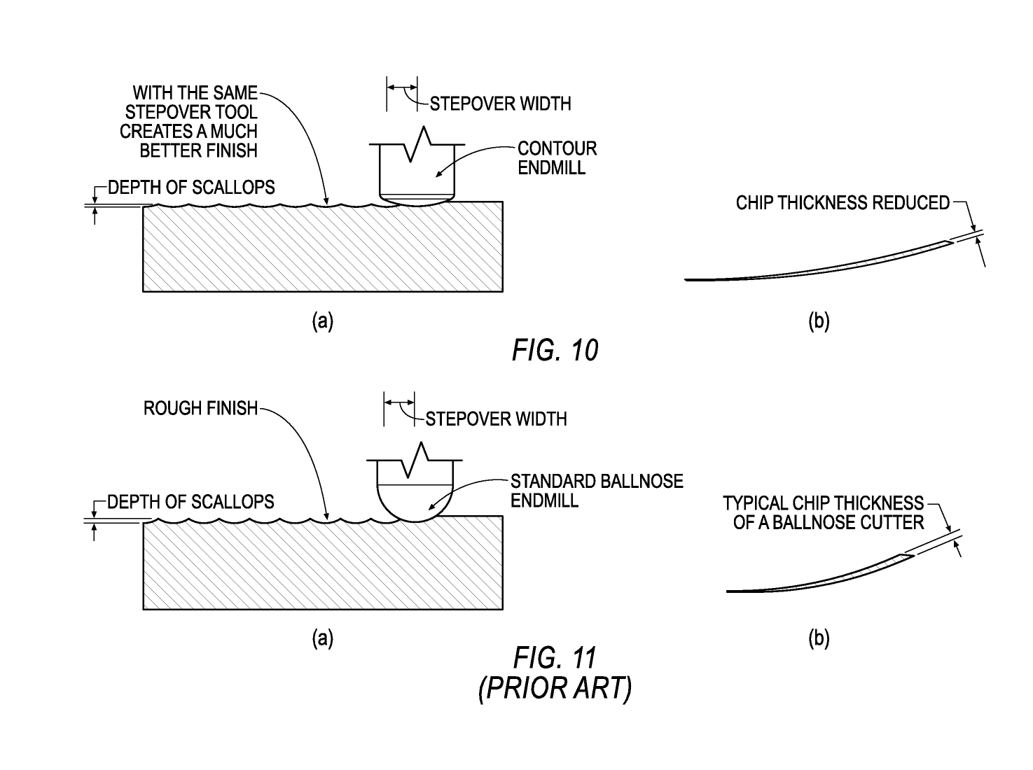

As shown in FIGS. 10(a) and (b), the major radius 26 being larger than more than one-half of the cutting diameter 18 provides several distinct advantages as compared to the conventional ball nose end mill shown in FIGS. 11(a) and (b). As shown in FIG. 10(a), the end mill 10 of the invention provides a much smoother finish with the same step over width as compared to the conventional ball nose end mill. As a result, the user spends less time finishing the workpiece. Alternatively, the user can increase the step over width, which will dramatically reduce cycle time. As shown in FIG. 10(b), the end mill 10 of the invention at the same feed rate produces chips having a thickness that is much less than the thickness of the chip produced by the conventional ball nose end mill shown in FIG. 11(b). Alternatively, the user can substantially increase the feed rate of the workpiece, which will dramatically reduce cycle time.

As described above, the end mill 10 of the invention offers many distinct advantages when compared to conventional ball nose end mills.

The patents and publications referred to herein are hereby incorporated by reference.

Having described presently preferred embodiments the invention may be otherwise embodied within the scope of the appended claims.

What is claimed is:

1. A contour end mill, comprising:
a shank portion; and
a cutting portion defining a cutting diameter, a corner radius and a major radius,
wherein the major radius is greater than one-half of the cutting diameter.

2. The end mill of claim 1, wherein the corner radius is leas than one-half of the cutting diameter.

3. The end mill of claim 1, wherein the cutting portion further includes a plurality of flutes defining a core diameter, a radial rake angle, a rake check point, a radial primary angle, and a radial secondary angle.

4. The end mill of claim 1, wherein the cutting portion further includes a primary relief, a secondary relief, a helical axial rake gash, and a heel relief.

5. The end mill of claim 4, wherein a cutting edge is formed at an intersection between the helical axial rake gash and the primary relief.

6. The end mill of claim 4, wherein the helical axial rake gash is offset from a central, longitudinal axis of the end mill.

7. The end mill of claim 4, wherein the helical axial rake gash is formed at a gash angle with respect to a central, longitudinal axis of the end mill.

8. The end mill of claim 1, wherein the cutting portion further includes a center web having a non-zero thickness.

9. A contour end mill, comprising:
a shank portion; and
a cutting portion defining a cutting diameter, a corner radius and a major radius, the cutting portion further including a plurality of flutes defining a core diameter, a radial rake angle, a rake check point, a radial primary angle, a radial secondary angle, a primary relief, a secondary relief, a helical axial rake gash, a heel relief, and a cutting edge formed at an intersection between the helical axial rake gash and the primary relief,
wherein the major radius is greater than one-half of the cutting diameter, and
wherein the corner radius is less than one-half of the cutting diameter.

10. A method of end milling a workpiece using a contour end mill, the end mill comprising a shank portion; and a cutting portion defining a cutting diameter, a corner radius and a major radius, the corner radius less than one-half of the cutting diameter, the major radius greater than one-half of the cutting diameter, the method comprising:
performing a cutting operation with the major radius of the cutting portion; and
performing a cutting operation with the corner radius of the cutting portion.
